(19) United States
(12) Patent Application Publication
(10) Pub. No.: US 2023/0225269 A1
(43) Pub. Date: Jul. 20, 2023

(54) PLANT CARRIER AND HYDROPONIC AND AEROPONIC GROWTH APPARATUS

(71) Applicants: 2251600 ALBERTA LTD., Lethbridge (CA); HUNTLEY VENTURES INC., West Kelowna (CA)

(72) Inventors: Mitchell Dwayne GORGICHUK, Lethbridge (CA); Dennis HUNTLEY, West Kelowna (CA)

(73) Assignees: 2251600 ALBERTA LTD., Lethbridge (CA); HUNTLEY VENTURES INC., West Kelowna (CA)

(21) Appl. No.: 18/190,710

(22) Filed: Mar. 27, 2023

Related U.S. Application Data
(63) Continuation of application No. PCT/CA2021/051326, filed on Sep. 23, 2021.
(60) Provisional application No. 63/084,790, filed on Sep. 29, 2020.

(51) Int. Cl. A01G 31/02

(52) U.S. Cl. CPC A01G 31/02

(57) ABSTRACT

A plant growth apparatus that includes a container with a main cylindrical portion having a main upper opening and a lateral reservoir. The lateral reservoir has a reservoir opening angled downward from the upper opening. The apparatus includes a lid configured for connection to the main upper opening. The lid is defined by one or more apertures. The apparatus further includes a plant carrier configured for connection to the one or more apertures, such that a majority portion of the plant carrier extends into the main cylindrical portion. Also disclosed is a kit for assembling a plant growth apparatus that includes a container defined by a main cylindrical portion with a main upper opening and a lateral reservoir in fluid communication with the main cylindrical portion. The lateral reservoir has a reservoir opening angled downward from the upper opening. The kit also includes a cover for the reservoir opening.

### CROSS-REFERENCE TO RELATED APPLICATIONS

This application is a Bypass Continuation Application to PCT International Application No. PCT/CA2021/051326, filed Sep. 23, 2021, and entitled “Plant Carrier and Hydroponic and Aeroponic Growth Apparatus”, which claims priority benefit under 35 U.S.C. § 119(e) of U.S. Provisional Pat. Application No. 63/084,790, filed Sep. 29, 2020. Both applications and the disclosures of each are hereby incorporated herein by reference in their entirety.

### TECHNICAL FIELD

The technology relates to hydroponic and aeroponic arrangements for growing plants and more particularly to arrangements using containers such as buckets to facilitate manipulation of plant growth conditions in the presence of air and water.

### BACKGROUND OF THE INVENTION

Hydroponics is a type of horticulture and a subset of hydroculture, which is a method of growing plants, usually crops, without soil, by using mineral nutrient solutions in an aqueous solvent. Terrestrial plants may be grown with only their roots exposed to the nutritious liquid, or, in addition, the roots may be physically supported by an inert medium such as perlite, gravel, or other substrates. Despite inert media, roots can cause changes of the rhizosphere pH and root exudates can affect the rhizosphere biology. In static solution culture, plants are grown in containers of nutrient solution, such as glass jars, pots, buckets, tubs, or tanks.

Aeroponics is a system wherein roots are continuously or discontinuously kept in an environment saturated with fine drops (a mist or aerosol) of nutrient solution. The method requires no substrate and entails growing plants with their roots suspended in a deep air or growth chamber with the roots periodically wetted with a fine mist of atomized nutrients. Excellent aeration is the main advantage of aeroponics. Aeroponic techniques have proven to be commercially successful for propagation, seed germination, seed potato production, tomato production, leaf crops, and micro-greens.

Systems for hydroponics and aeroponics growth of plants are described in U.S. Pats. 4,369,598, 6,612,069, 6,918,207, 9,532,517, 10,080,335, and 10,681,877, US Patent Publication Nos. 20100162624, 20150237807, 20150334928, 20150366147, 20170086397, 20200008374, U.S. Design Pats. D730,770 and D801,212, and Japanese Patent JP6455911B2, each of which is incorporated herein by reference in its entirety.

### SUMMARY OF THE INVENTION

According to one embodiment, there is provided a plant carrier for use with a hydroponics growth apparatus. The plant carrier includes an upper connector configured for connection to an aperture in a lid of a container of the apparatus such that a majority portion of the carrier extends below the underside of the lid. The connector is defined by an upper opening permitting a stem of a plant to extend upward through the aperture when the carrier is connected to the lid. One or more support members extend downward from the upper connector and a lower bowl is connected to the one or more support members. The lower bowl is provided to support a seed, a plant growing substrate, or roots of the plant.

The plant carrier may have two support members, three support members or four support members. In some embodiments, the plant carrier includes three support members defining three windows between the upper connector and the bowl.

The plant carrier may further include a flange extending outward from an outer edge of the bowl for promoting lateral spread of the roots of the plant. The flange may be sloped downward from the outer edge of the bowl.

In some embodiments, the upper connector, the support members and the lower bowl are of monolithic construction. In other embodiments, the upper connector, the support members, the lower bowl and the flange are of monolithic construction.

The lower bowl may be separated from the upper connector at a distance of at least about 5 cm.

The bowl may be conical or frustoconical in shape and may have a solid sidewall with no openings. In some embodiments, the bowl has an inner depth of at least about 0.5 cm.

According to another embodiment, there is provided a hydroponics growth apparatus. The apparatus includes a container and a lid having one or more apertures which is configured for connection to an upper opening of the container, as well as one or more plant carriers as described herein.

The container may include a lateral reservoir in fluid flow communication with a main reservoir. The lateral reservoir may have an upper opening for providing manual access to the main reservoir. In some embodiments, the upper opening of the lateral reservoir is angled downwards from an upper edge of the container.

In some embodiments, the container includes a hinged cover configured to block access to the upper opening of the lateral reservoir. The hinged cover may be configured to hang vertically downward when disengaged from the upper opening of the lateral reservoir.

The lid of the apparatus may include two or more extensions for connection to support lines for the plant or for connection of the lid to a scaffold. In some embodiments, the lid includes four extensions for connection to support lines for the plant or for connection of the lid to a scaffold. The extensions may be hooks or brackets.

In some embodiments, the lid includes an inner circumferential sidewall configured to enter the container when the lid is connected to the upper opening of the container. The circumferential sidewall may include a cut-out portion for alignment with the upper opening of the lateral reservoir. The inner circumferential sidewall provides the lid with an extended height greater than the height of the plant carrier.

In some embodiments, the reservoir opening has an area of about 110 cm² to about 156 cm². In some embodiments, the area of the reservoir opening is greater than an area of the bottom surface of the reservoir. The area of the bottom surface of the reservoir may be about 76.5 cm² to about 95 cm².

According to another embodiment, there is provided a kit for promoting hydroponic growth of one or more plants, the kit may include two or more containers and a first lid configured for connection to at least one of the containers. The first lid may have a plurality of apertures configured to receive a plant carrier as described herein. The kit may include a second lid configured for connection to at least one of the containers, the second lid may have a central aperture configured to receive a plant carrier as described herein.

The kit may include instructions to grow a plurality of seeds or clones into plants using the first lid and one of the containers and to transfer one of the plants, to the second lid and another one of the containers upon reaching an indicated growth stage.

The containers may include an upper cut-out portion providing access to the plant carrier, while the plant carrier remains connected to the lid.

In some embodiments of the kit, the first lid and the second lid include two or more extensions for connection to support lines for the plant or for connection of the lid to a scaffold. In some embodiments, the lid includes four extensions for connection to support lines for the plant or for connection of the lid to a scaffold. The extensions may be hooks or brackets.

In some embodiments of the kit, at least one of the containers includes a lateral reservoir in fluid flow communication with a main reservoir. The lateral reservoir has an upper opening for providing manual access to the main reservoir. The upper opening of the lateral reservoir may be angled downwards from an upper edge of the container.

In some embodiments of the kit, the container includes a hinged cover configured to block access to the upper opening of the lateral reservoir. The hinged cover may be configured to hang vertically downward when disengaged from the upper opening of the lateral reservoir.

In some embodiments of the kit, the first lid or the second lid or both lids may include an inner circumferential sidewall configured to enter the container when the lid is connected to the upper opening of the container. The circumferential sidewall may have a cut-out portion for alignment with the upper opening of the lateral reservoir to provide the lid with an extended height greater than the height of the plant carrier.

According to another embodiment, there is provided a plant growth apparatus. The apparatus includes a container defined by a main cylindrical portion with a main upper opening and a lateral reservoir in fluid communication with the main cylindrical portion, the lateral reservoir having a reservoir opening angled downward from the upper opening. The apparatus includes a lid configured for connection to the main upper opening, the lid defined by one or more apertures. The apparatus further includes a plant carrier configured for connection to the one or more apertures, such that a majority portion of the plant carrier extends into the main cylindrical portion to become immersed in growth medium held in the container, when the apparatus is in use.

The apparatus may further include a cover for the reservoir opening. In some embodiments, the reservoir cover includes an upper angled portion and a horizontal portion. The horizontal portion may be bendable and biased downwards to a normally horizontal orientation.

In some embodiments, the reservoir opening of the container is defined by opposed angled edges of the lateral reservoir configured to connect to the upper angled portion of the reservoir cover. The opposed angled edges join a forward horizontal edge configured to connect to the horizontal portion of the reservoir cover.

The lid may include a plurality of peripheral tabs configured to connect to scaffold members to provide an upper plant support structure.

In some embodiments, the lid is radially tapered downward to provide a drain slope towards each of the one or more apertures.

The plant carrier may include a plurality of ridges below an upper peripheral edge of the plant carrier which are configured to fit into peripheral grooves formed adjacent to the one or more apertures of the lid. This provides a connection mechanism for connecting the plant carrier to the lid.

The plant carrier may include a plurality of support members extending from an upper ring portion downward to a bowl portion. The support members may be angled inwardly towards the bowl portion. This arrangement provides the plant carrier with a frustoconical shape which facilitates centralization of the bowl portion and connection of the plant carrier to one of the one or more apertures of the lid without disturbing roots of a plant extending from the plant carrier. In some embodiments, the plant carrier does not include cross members between the support members.

In some embodiments, the bowl portion of the plant carrier is an inverted bowl formed of a central flat portion and a plurality of downward extensions.

The plant carrier may include a plurality of shelves extending from an inner surface of the ring portion into a main opening of the plant carrier. The plurality of shelves is provided to support a collar for centralizing and supporting a plant within the plant carrier.

The upper peripheral edge of the plant carrier may be provided with a polygonal shape to present a plurality of corners in order to facilitate manual disconnection of the plant carrier from the lid. In some embodiments, the upper peripheral edge of the plant carrier is octagonal in shape.

Another aspect of the technology described herein provides a kit for assembling a plant growth apparatus. The kit may include a container defined by a main cylindrical portion with a main upper opening and a lateral reservoir in fluid communication with the main cylindrical portion. The lateral reservoir may have a reservoir opening angled downward from the upper opening. The kit also includes a cover for the reservoir opening.

In some embodiments of the kit, the cover includes an upper angled portion and a horizontal portion, wherein the horizontal portion is bendable and biased downwards to a horizontal orientation.

The kit may also include one or more lids configured for connection to the main upper opening, the lids defined by one or more apertures.

The kit may also include a plurality of scaffold members configured for connection to the one or more lids.

The kit may also include one or more plant carriers configured for connection to the one or more apertures.

The kit may also include one or more collars for supporting a plant extending from the one or more plant carriers.

### BRIEF DESCRIPTION OF THE DRAWINGS

Various objects, features and advantages of the technology will be apparent from the following description of particular embodiments of the technology, as illustrated in the accompanying drawings. The drawings are not necessarily to scale, emphasis instead being placed upon illustrating the principles of various embodiments of the technology. Similar reference numerals indicate similar components.

FIG. 1 is a perspective view of one embodiment of a hydroponic/aeroponic growth apparatus 10, in accordance with an aspect of the present disclosure;

FIG. 2A is a side elevation view of one embodiment of a plant carrier 22, in accordance with an aspect of the present disclosure;

FIG. 2B is a perspective view of plant carrier embodiment 22, in accordance with an aspect of the present disclosure;

FIG. 3 is another perspective view of the hydroponic/aeroponic growth apparatus 10 showing a lateral reservoir 13, in accordance with an aspect of the present disclosure;

FIG. 4 is a perspective view of a different lid embodiment 160 having a rigid support insert 164 and four apertures 162a-d, in accordance with an aspect of the present disclosure;

FIG. 5 is a side elevation view of the plant carrier embodiment 22 with an additional lower flange 34, in accordance with an aspect of the present disclosure;

FIG. 6 is a perspective view of the lid 16 with a scaffold formed of horizontal supports 27a,b and vertical supports 29a-d, with the vertical supports 27a,b connected to the extensions 18a-d, in accordance with an aspect of the present disclosure;

FIG. 7A is a perspective view of a partial growth assembly 100 which includes a container 120 and a cover 150 for the lateral reservoir 130 of the container 120, in accordance with an aspect of the present disclosure;

FIG. 7B is an exploded perspective view of the assembly 100 revealing detail of the opposed upper perimeter edges 131, 132 of the lateral reservoir 130, in accordance with an aspect of the present disclosure;

FIG. 8 is a perspective view of one embodiment of a lid 260 configured to connect to the main upper perimeter of the container 120 which is shown in FIGS. 7A and 7B, in accordance with an aspect of the present disclosure;

FIG. 9 is a perspective view of the lid 260 showing connected scaffold members SM provided to support a growing plant, in accordance with an aspect of the present disclosure;

FIG. 10 is a perspective view of another embodiment of a lid 360 configured to connect to the upper perimeter of the container 120 shown in FIGS. 7A and 7B, in accordance with an aspect of the present disclosure;

FIG. 11A is a perspective view of another embodiment of a plant carrier 220, in accordance with an aspect of the present disclosure;

FIG. 11B is a top view of the plant carrier 220, in accordance with an aspect of the present disclosure;

FIG. 12A is a top view of the plant carrier 220 showing placement of a collar 401 with a central opening 402 on the inner tabs 224a,b,c of the plant carrier 220 which are best seen in FIG. 11B, in accordance with an aspect of the present disclosure; and

FIG. 12B is a side view of the plant carrier 220 showing placement of a collar 401 on the inner tabs 224a,b,c of the plant carrier 220 and a plant P extending from the collar 401, in accordance with an aspect of the present disclosure.

### DETAILED DESCRIPTION OF THE INVENTION

In hydroponics and aeroponics growth systems, a component known as a “net pot” is provided in the form of a basket which is used to hold a seed or clone within a larger container while it grows to a point when it has sufficient root mass to permit transplantation into a larger container. Conventional net pots are usually frustoconical or cylindrical in shape and have a net-like or mesh sidewall and a flat net-like or mesh bottom to permit roots to grow outward and downward from the net pot. The present inventor has recognized shortcomings in this conventional arrangement. Among such shortcomings is that as the plant grows under hydroponic and/or aeroponic conditions, the roots extending from the mesh openings on the sides and the bottom of the net pot become entangled. This entanglement complicates transplantation efforts because roots may be damaged or broken when the plant is removed from the net pot.

In recognizing and addressing these problems, the inventor discovered that an improved plant carrier as a replacement for a net pot could be configured to promote outward growth of roots with significantly less tangling. The improved plant carrier is configured for connection to a lid of a container-based hydroponic/aeroponic growth apparatus, embodiments of which are described hereinbelow. These embodiments permit the growing plant to be conveniently transferred from a first container to a second container and to be removed from the plant carrier with minimal damage to the roots, as well as providing an environment which encourages the roots to spread outward from the plant carrier to facilitate examination and treatment of the roots to enhance growth of the plant.

Furthermore, the embodiments of the container and the lid used in an apparatus together the improved plant carrier have certain advantageous features permitting convenient access to the plant while it is held in the carrier within the container and on the lid following removal of the lid from the container. These features which are described in detail hereinbelow, represent significant improvements in the fields of hydroponic and aeroponic plant growth.

Various embodiments will now be described with reference to the figures. For the purposes of illustration, components depicted in the figures are not necessarily drawn to scale. Instead, emphasis is placed on highlighting the various contributions of the components to the functionality of various aspects of the technology. A number of possible alternative features are introduced during the course of this description. It is to be understood that, according to the knowledge and judgment of persons skilled in the art, such alternative features may be substituted in various combinations to arrive at different embodiments of the present technology.

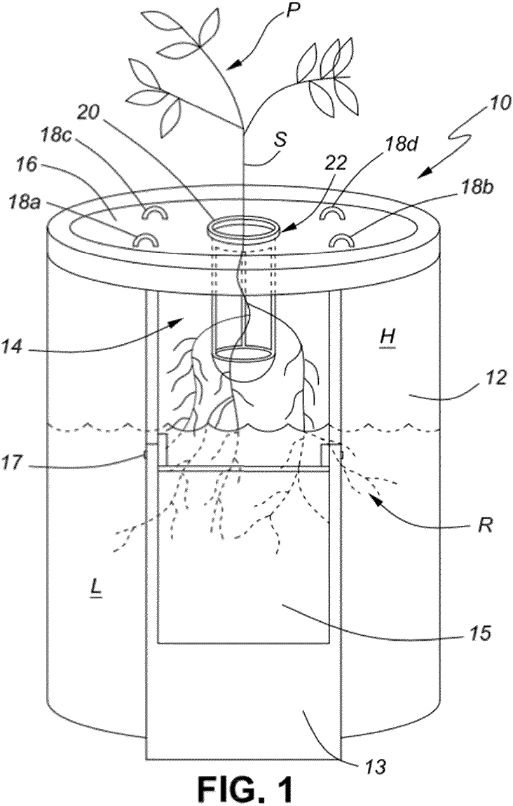

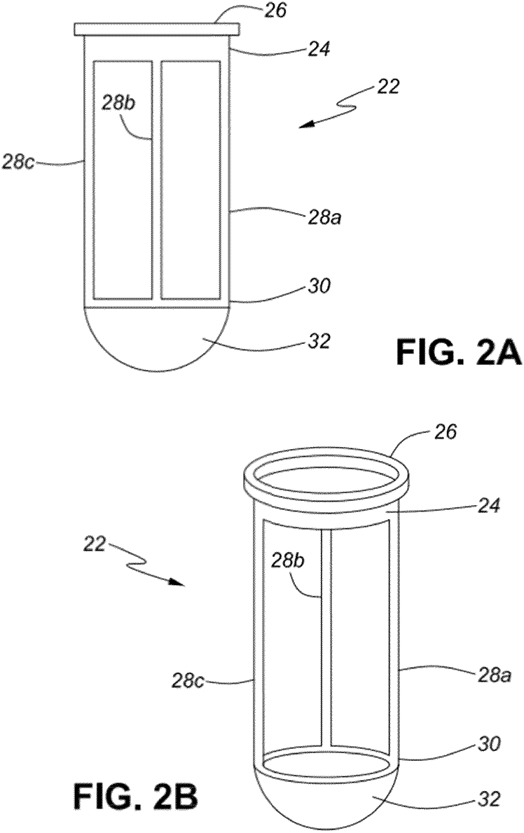

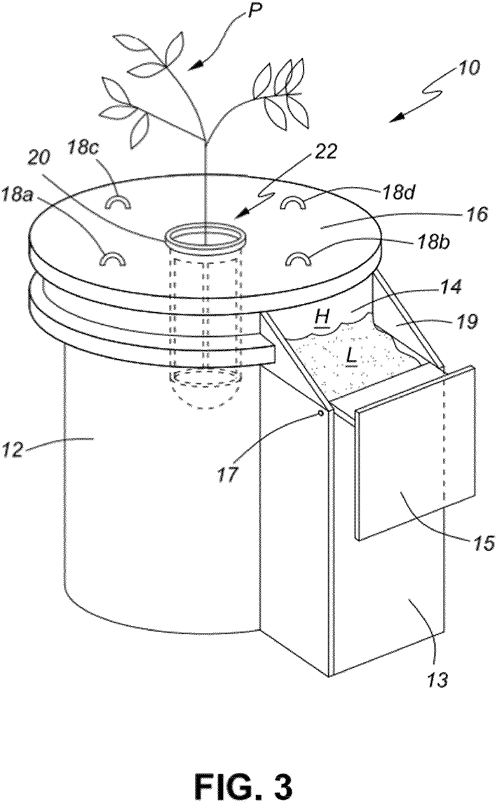

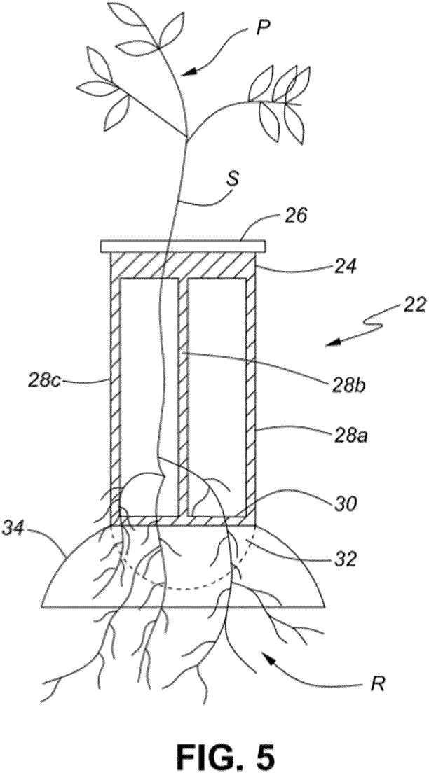

FIGS. 1 and 3 illustrate two different perspective views of a growth apparatus 10 which includes a container 12. It is seen that the container 12 has a lateral opening 14, and a lid 16 with a central aperture 20 which is configured to receive a plant carrier 22. The plant carrier 22 will be described in more detail with respect to FIGS. 2A, 2B and 5. In FIGS. 1 and 3, it is seen that an upper portion of a plant P extends upward from the plant carrier 22. The stem S of the plant P extends downward within the plant carrier 22 and the roots R of the plant P extend from the open sides of the plant carrier 22 with upper portions of the roots R being in a head space H of the container 12 and lower portions of the roots R being suspended in liquid L. It is the presence of the head space H and the liquid L that provide the apparatus with characteristics of a hydroponic and an aeroponic plant growing system.

In this apparatus embodiment 10 of FIGS. 1 and 3, the lid 16 includes four extensions 18a-d which may be used as an anchor points to suspend the lid 16, to connect the lid 16 to a scaffold (not shown), or for attaching a cord (not shown) to provide support for the growing stem S.

As best shown in FIG. 3, the container 12 has a lateral reservoir 13 which, in this embodiment 10, is a rectangular box shape extending from a generally cylindrical main portion of the container 12. It is to be understood that the interior side walls of the lateral reservoir 13 are contiguous with the main interior sidewall of the container 13. Other container and reservoir shapes are possible and within the scope of the claims. It is seen in FIG. 3 that the rectangular upper opening 14 is formed at the top of the lateral reservoir 13 and is angled downward and outward from the upper edge of the container 12, to which the lid 16 is connected. This angled opening 14 of the lateral reservoir 13 provides convenient manual three-dimensional access to the main reservoir of the container 16 where the plant carrier 22 extends downward. This three-dimensional access is greater than would be provided by a non-angled horizontally defined opening occupying only two dimensions. The enhanced manual access facilitates operations such as aeration, addition of nutrients and other components to the liquid, addition and removal of liquid, and examination and treatment of roots of the plant P held in the plant carrier 22.

A cover 15 is provided to block the angled opening 14. The cover 15 is connected to side walls of the lateral reservoir via a hinge 17 which is configured to displace the cover 15 downward along a front facing wall of the lateral reservoir 13 as shown in FIGS. 1 and 3. This arrangement is more advantageous than a top-hinged arrangement because it takes advantage of gravity to keep the cover 15 in a disengaged position where it will not interfere with manual access operations via the angled opening 14.

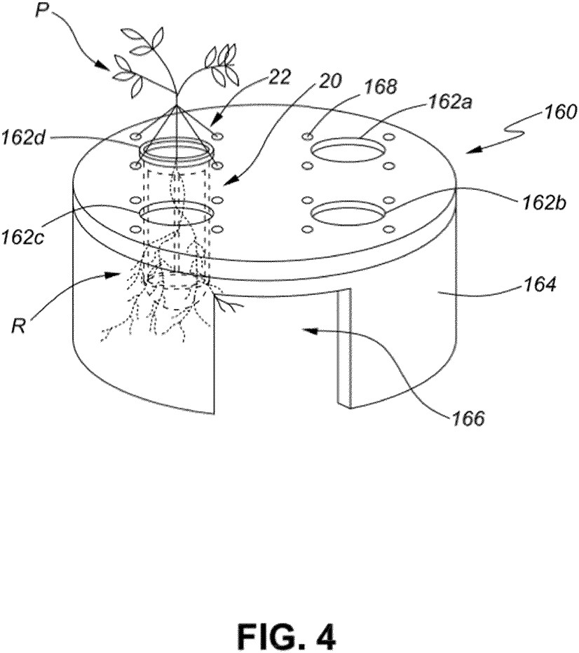

Turning now to FIGS. 2A and 2B, there is shown a plant carrier 22 which is used in the apparatus embodiment of FIGS. 1 and 3 and which may be used in other apparatus embodiments, such as for example using a lid 160 as shown in FIG. 4 which has four apertures 162a-d. The plant carrier 22 has an upper connector 26 which in this embodiment is simply a wider diameter ring structure which holds the upper end of the plant carrier 22 in place on the lid such that a majority portion of the plant carrier 22 extends downward into the container 12 of the apparatus 10 shown in FIGS. 1 and 3. Alternative embodiments may include other types of connectors.

In keeping with the advantage of providing as much open space as possible in the main body of the plant carrier 22 to promote spreading of the roots R outward from the plant carrier 22, the plant carrier 22 is provided with three relatively narrow support members 28a-c which provides the effect of forming three large rectangular circumferential windows, from which the roots of the plant P will extend as the plant grows. Therefore, the area occupied by the support members 28a-c represents a minority portion of the longitudinal circumference of the plant carrier 22 between the upper connector 26 and a lower bowl 32. The bowl 32 is connected at its top edge to a lower ring 30 connected to the support members 28a-c or formed integrally with the support members 28a-c. In this embodiment, the bowl 32 has a solid interior sidewall to prevent the roots R of the plant P from growing out of the bowl 32. This is advantageous in providing a space without roots directly below the plant carrier 22, which enhances aeration of the fluid in the container 12.

FIG. 5 illustrates a modification of plant carrier 22 to include a lower flange 34 which is connected to the bowl 32. In this embodiment, the flange 34 is connected to an upper portion of the bowl 32 but alternative positioning of the flange 34 is possible in alternative embodiments. Additional flanges may be provided above the bowl and coupled to the support members 28a-c to provide staged support for roots along the length of the plant carrier 22. In such embodiments with staged flanges (not shown), the flanges can be coupled to intermediate locations along the length of the support members 28a-c after the plant carrier 22 is installed in the lid 16 with manual access to do so being provided by the opening 14 in the lateral reservoir 13, for example when the apparatus embodiment 10 is used in conjunction with the plant carrier 22. In the embodiment shown in FIG. 5, the flange 34 slopes downward to promote downward growth of the roots. In some

In some embodiments, the flange 34 extends outward from the support members 28a-c by at least about 60 cm, at least about 65 cm, at least about 70 cm, at least about 75 cm or at least about 80 cm. In some embodiments, the flange 34 extends inwards between the support members by at least about 25 cm, at least about 30 cm, or at least about 35 cm.

The presence of the flange 34 is particularly useful in plant growth stages where roots R are growing outward to a significant extent and therefore should be considered an optional feature during early growth stages.

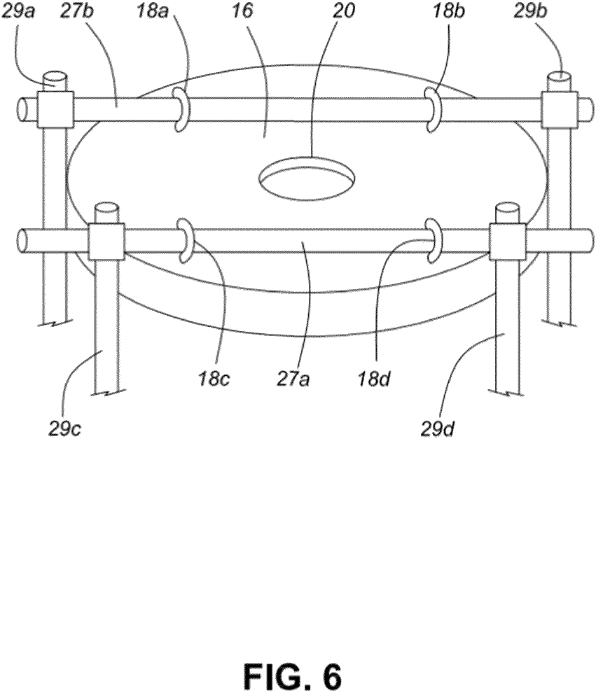

FIG. 6 illustrates an arrangement of the lid 16 being supported by a scaffold formed of horizontal supports 27a,b and vertical supports 29a-d, with the vertical supports 27a,b connected to the extensions 18a-d. This arrangement is useful in permitting support of the lid 16 after having been removed from the container 16. A plant and plant carrier is omitted from this view but it is to be understood that supporting the lid 16 with the scaffolding connected to the extensions 18a-d via the horizontal supports 27a,b allows a plant within a plant carrier, such as plant carrier 22 to remain in place in the aperture 20 and supported by the lid 16 and scaffolding.

In some embodiments, the plant carrier 22 has its lower bowl 32 separated from the upper connector at a distance of at least about 5 cm, at least about 6 cm, at least about 7 cm, at least about 8 cm, at least about 9 cm or at least about 10 cm. In some embodiments, the bowl 32 has a depth of at least about 0.5 cm, at least about 1 cm, at least about 1.5 cm, at least about 2 cm, at least about 2.5 cm or at least about 3 cm.

Some embodiments of the plant carrier 22 are of monolithic construction wherein the connector 26, the support members 28a-c, the bowl 32 and the flange 34 are formed of a durable polymer by injection molding or additive manufacturing.

FIG. 4 illustrates an alternative lid 160 which has four apertures 162a-d where a plant carrier 22 is installed in aperture 162d. The features of this lid 160 are now described in conjunction with the apparatus embodiment 10, in a scenario where lid 16 is replaced with lid 160. The lid 160 is provided with an inner circumferential sidewall 164 configured to enter the container 12 when the lid 160 is connected to the upper opening of the container 12. The circumferential sidewall 164 has a cut-out portion 166 for alignment with the upper opening 14 of the lateral reservoir 13. With this alignment, the circumferential sidewall 164 does not block the upper opening 14 of the lateral reservoir 13. The inner circumferential sidewall 164 provides the lid 160 with an extended height greater than the height of the plant carrier 22 to permit the lid 160 to rest on any flat surface (such as a tabletop or a floor) while retaining the plant carrier 22 in place in association with the aperture 162d, and preventing the bowl 32 of the plant carrier 22 from contacting the flat surface and pushing the plant carrier 22 out of the aperture 162d. The circumferential sidewall 164 also acts as a splash guard in situations where plant treatments are performed while the lid 160 is outside of the container 12. This embodiment of the lid 160 includes four extensions 168 around each one of the four apertures 162a-d. These extensions 168 are used as anchor points for anchoring the plant P and training it with respect to a desired growth pattern as shown for the plant P installed in aperture 162d.

An alternative embodiment of this lid 160 additionally includes an upper vertical wall at the upper edge of the lid 160 (not shown). This upper wall is provided to allow the upper flat surface of the lid 160 to be flooded with water, as desired to provide local humidity above the lid 160 as an enhancement to growth conditions, as well as containing spillage if a water is poured directly onto the plant held by this lid 160.

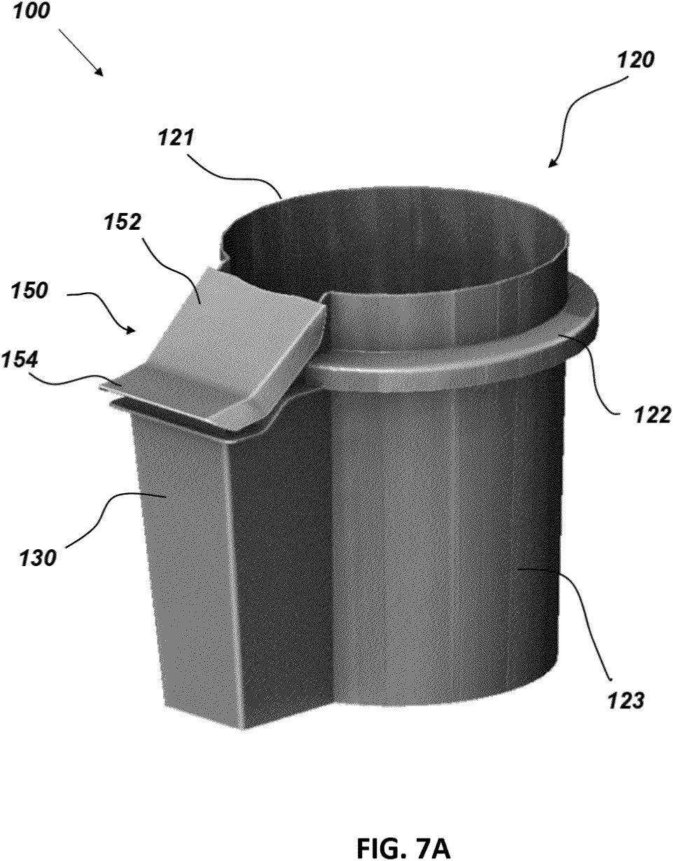

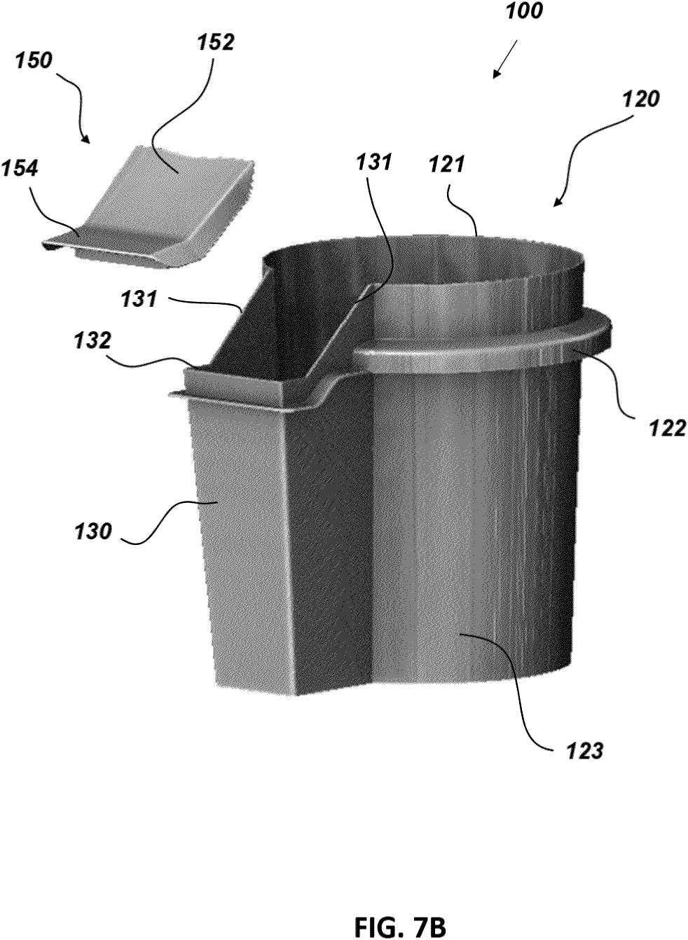

An embodiment of a partial assembly of a growth apparatus 100 is shown in FIGS. 7A and 7B where FIG. 7A illustrates the assembly which includes a container 120 and a reservoir cover 150 and FIG. 7B illustrates an exploded view of the same components. It is to be understood that this partial assembly 100 may be used with various embodiments of container lids and plant carriers to form a complete growth apparatus, such as the container lid and plant carrier embodiments described above and additional container lid and plant carrier embodiments to be described subsequently below.

It is seen that the partial assembly 100 of FIGS. 7A and 7B includes a container 120 having a main compartment 123 with a large upper opening defined by an upper perimeter 121. In some embodiments, this upper opening is circular and has an inner diameter of about 270 cm to about 290 cm. This embodiment of the container 120 includes a circumferential ridge 122 generally adjacent to the upper perimeter 121 which is provided to facilitate manual grasping of the container 120 in an upright orientation so that a user can move the container to another location as may be required (this feature is also shown for container 12 in FIG. 3). In certain preferred embodiments, the ridge 122 may extend at least about 2 cm laterally outward from the sidewall of the main compartment, in order to provide a suitable manual gripping edge to facilitate carrying the assembly 100 in an upright fashion during manual transport, to avoid disturbing a plant growing therein.

The container 120 has a lateral reservoir 130 with a reservoir opening which is seen in the exploded view of FIG. 7B. A reservoir cover 150 is provided to cover the reservoir opening. The reservoir cover 150 has an upper angled portion 152 configured to conform to the upper angled opposed edges 131 of the reservoir 130. The opening of the reservoir 130 is angled downward and outward from the upper perimeter 121 to provide enhanced vertical access to the interior of the container 120 such that a user can gain manual entry into the interior of the container 120 with both hands. In some embodiments, the opening of the reservoir 130 has a rectangular shape with a length ranging from about 11 cm to about 13 cm and a width ranging from about 10 cm to about 12 cm to provide a reservoir opening area of about 110 cm² to about 156 cm². In one preferred embodiment, the opening of the reservoir has a width of about 11 cm and a length of about 12 cm to provide a reservoir opening area of about 132 cm². In some embodiments the reservoir 130 has a bottom surface with a reduced area relative to the area of the reservoir opening. In some embodiments, the bottom surface of the reservoir 130 has a width of about 8.5 cm to about 9.5 cm and a length of about 9 cm to about 10 cm to provide a bottom surface area of about 76.5 cm² to about 95 cm². In one preferred embodiment, the bottom surface width is about 9 cm² and the bottom surface length is about 9.5 cm² to provide a bottom surface area of about 85.5 cm². It is to be understood that the tapering of the reservoir 130 due to differing surface areas of the upper opening and lower surface is advantageous because it facilitates stacking of containers 120 on top of each other in the same orientation adopted in normal operation and is therefore useful for shipping and retail arrangements.

As described above for container embodiment 12, the three-dimensional access provided by the opening of the reservoir 130 is greater than would be provided by a non-angled horizontally defined opening occupying only two dimensions. The enhanced manual access facilitates operations such as aeration, addition of nutrients and other components to the liquid, addition and removal of liquid, and examination and treatment of roots of the plant.

The opening of the reservoir 130 also has a shorter forward horizontal edge 132. The reservoir cover 150 also has a horizontal portion 154 which is bendable relative to the upper angled portion 152 to facilitate insertion of one or more conduits which may be used for aeration of liquids in the container or for recirculation of fluids as may be required. While bendable upward, the horizontal portion 154 is biased towards the horizontal edge 132 when the cover is installed on the reservoir opening. The horizontal portion 154 of the reservoir cover 150 prevents light and airborne contaminants from entering into the container 120. The corner between the angled opposed edges 131 and the horizontal edge 132 provides support for the action of upward bending the horizontal portion 154 from its normally biased downward horizontal position. When the horizontal portion 154 is bent upward, a gap is created for placement of a hose into the reservoir 130 for aeration of the growth medium or other purposes. This gap will subsequently close when the horizontal portion 154 is released and biasedly moves downward. Closure of this gap prevents light from entering the interior of the container 120 to maintain protection of the roots of a plant growing therein from ultraviolet light and airborne contaminants. This reservoir cover embodiment 150 is completely removable from the reservoir opening and thereby allows a simpler construction of two separate moldable parts which permits the reservoir cover 150 to be press-fitted to the upper opening of the reservoir 130. This arrangement does not require extra hardware for a hinge, which is used for the cover 15 of apparatus embodiment 10, shown in FIG. 3 and therefore is less expensive to manufacture.

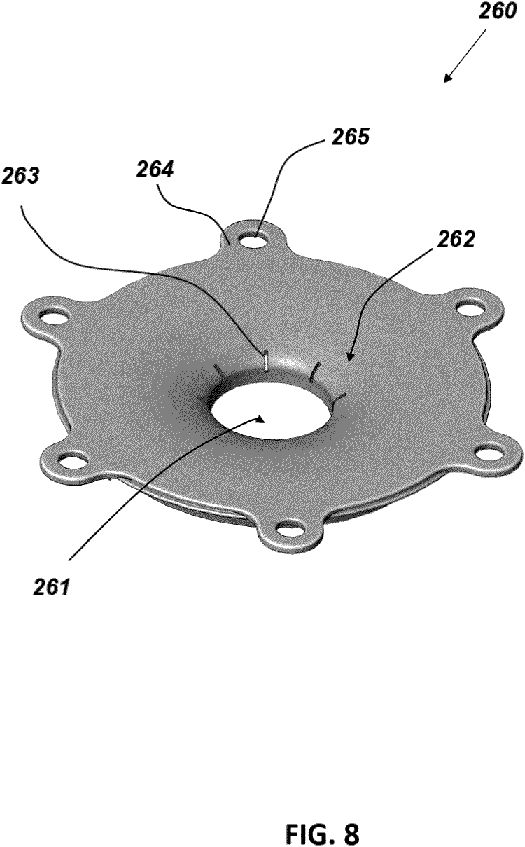

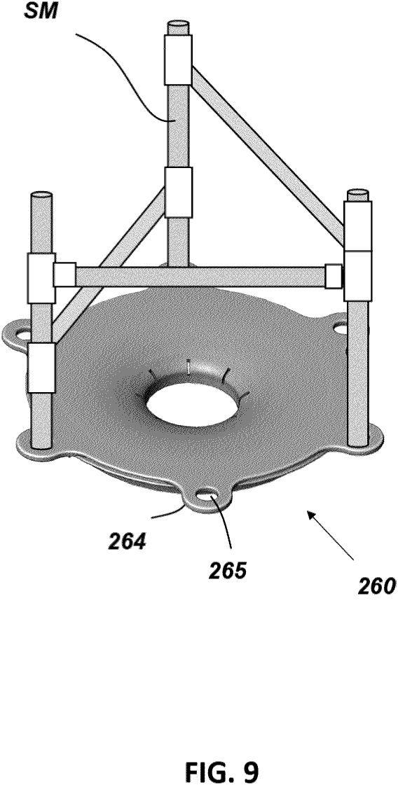

Turning now to FIGS. 8 to 10, two different embodiments of lids configured to connect to the container 120 described above, will now be described. One lid embodiment 260 (see FIGS. 8 and 9) includes a single central aperture 261 to permit emergence of a growing plant (not shown). This lid 260 has an upper surface which is generally flat near its perimeter but which transitions to a radial downward sloped surface 262 which acts as a drain to induce liquids to flow off the surface and downwards into the aperture 261. The aperture 261 is surrounded by a plurality of grooves 263 which cooperate with matched ridges on an embodiment of a plant carrier 220 described below, for connection of the plant carrier 220 to the lid 260. While not all grooves 263 are visible in the perspective views of FIGS. 8 and 9, it is to be understood that the lid 260 includes eight equi-spaced grooves 263. Other connecting arrangements are possible in alternative embodiments which may employ other means of connecting the plant carriers to the apertures of the lids. This lid embodiment 260 also includes a plurality of peripheral tabs 264, each provided with an opening 265 for installation of a scaffold member SM as shown in FIG. 9. In some embodiments, the openings 265 are dimensioned to accept a common plastic pipe diameter such as a diameter of about 2.0 cm to about 2.4 cm, for example, to provide a suitable balance between provision of a lightweight scaffold members SM which are sufficiently stable to customize the scaffold with various arrangements of vertical and horizontal support members to generate a scaffold structure to meet the support requirements of various plants. The growing and extending branches of the plant can be temporarily tied to the scaffold members SM until they no longer require such support.

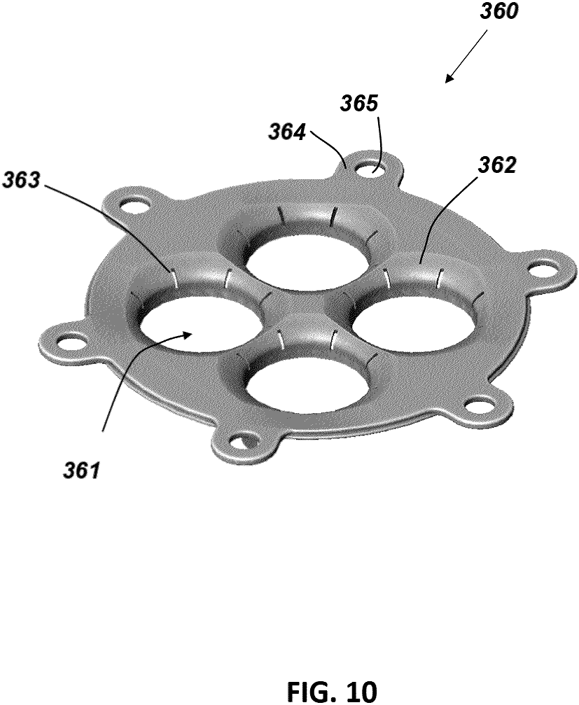

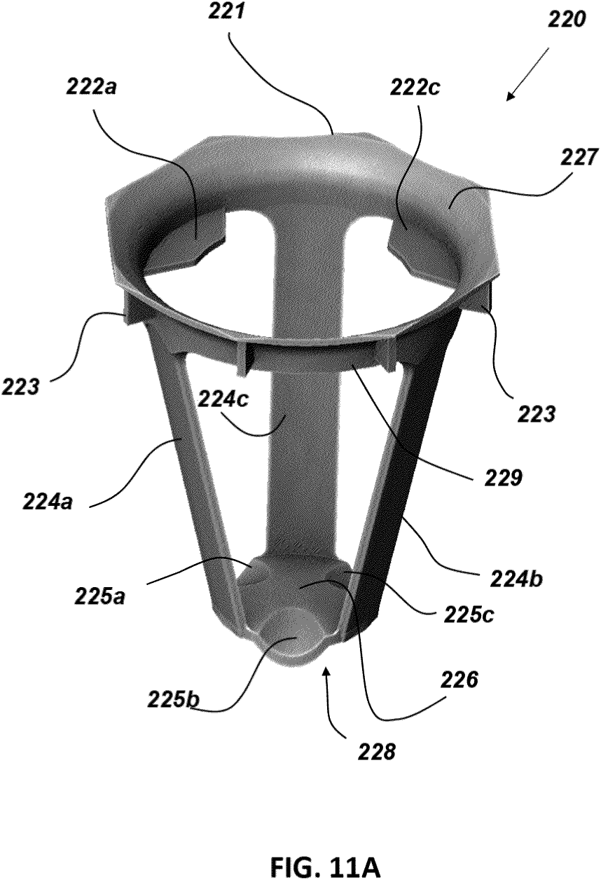

A second embodiment of a lid 360 is illustrated in FIG. 10. This embodiment 360 includes four central apertures 361 of similar dimension, each having radial downward sloped surfaces 362 and including eight equi-spaced grooves 363 for connection of plant carriers, as well as peripheral tabs 364 with openings 365 for connection of scaffold members SM in a manner similar to the arrangement shown in FIG. 9. In this particular embodiment 360, the four central apertures 361 have similar dimensions and grooves 363 intended for placement of plant carriers having similar dimensions and features, such as the plant carrier example embodiment described below.

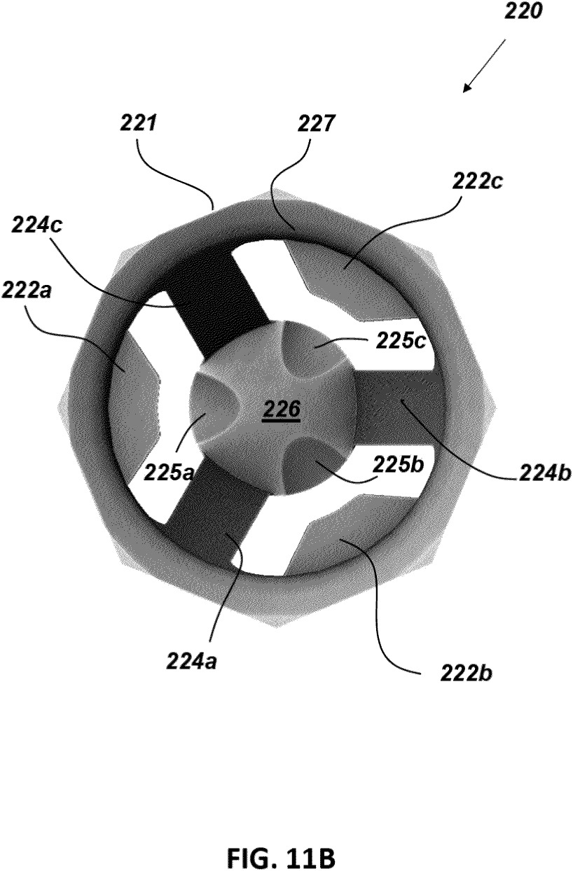

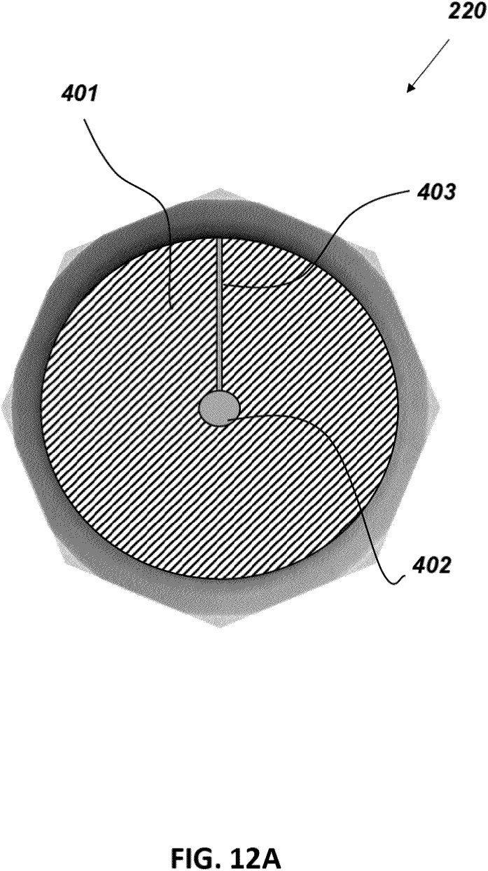

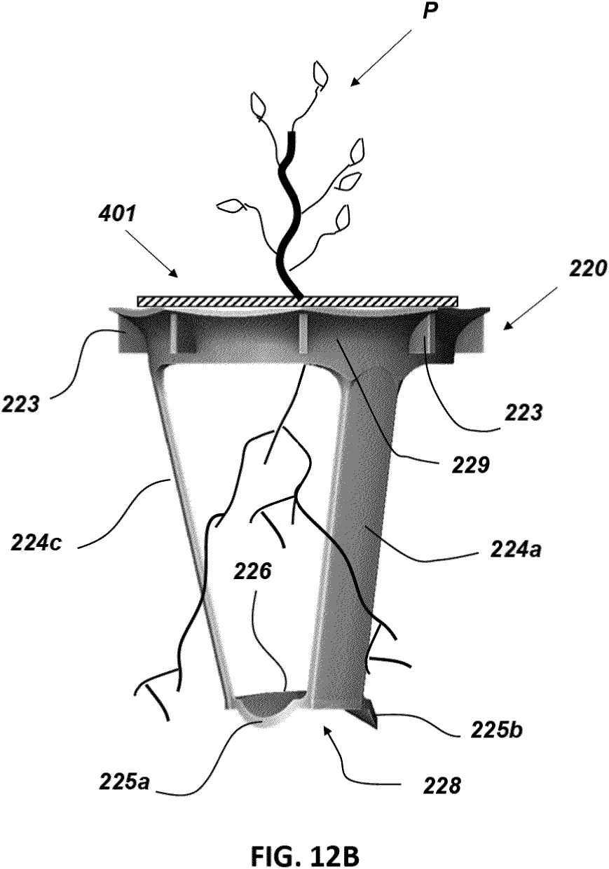

Turning now to FIGS. 11 and 12, there is shown another embodiment of a plant carrier 220. This plant carrier 220 may be configured for connection to a lid having aperture features similar to those of lid embodiments 260 and 360 as well as alternative lid embodiments with complementary grooves surrounding the aperture(s). The plant carrier 220 includes ridges 223 formed adjacent to the upper peripheral edge 221 of the plant carrier 220. The ridges 223 are configured for insertion into the complementary grooves surrounding an aperture of a lid of a growth apparatus (for example ridges 263 of lid embodiment 260 and ridges 363 of embodiment 360). This arrangement provides secure connection of the plant carrier 220 to the lids 260, 360. The plant carrier 220 has an octagonal shaped upper perimeter edge 221. Other polygonal geometries of the upper peripheral edge may be provided in alternative embodiments. The octagonal shape is advantageous because it presents eight corners to facilitate manual disconnection of the plant carrier 220 from the aperture of the lid when it is time to move a growing plant out of the container 120. The upper peripheral edge 221 transitions inwardly to a radial sloped surface 227 generally consistent with the radial sloped surfaces of lid embodiments 260 and 360, which are provided to facilitate drainage of liquids on the lid into the container 120 as described above.

The ridges 223 are formed in a ring portion 229 which is formed directly below the peripheral edge 221 in this embodiment. The ring portion 229 and its eight equi-spaced circumferential ridges 223 serve as the connector component of the plant carrier. Support members 224a,b,c are connected between the ring portion 229 and a lower inverted bowl 228 which is best seen in FIG. 12B. The support members 224a,b,c are angled downwards towards the bowl 228, thereby providing the plant carrier 220 with a frustoconical shape which is tapered towards the bottom. The frustoconical shape feature provides the advantage of minimizing contact of the roots of the plant with the edges of the aperture of the lid when the plant carrier 220 is removed from a lid such as the lid of embodiments 260 and 360.

The bowl 228 which is formed from a central flat portion 226 and downward extensions 225a,b,c is inverted relative to the bowl 32 of plant carrier embodiment 22 shown in FIGS. 2A and 2B. The bowl 228 therefore encourages spreading of roots of the plant downward and outward in a manner similar to the spreading induced by the flange 34 of the plant carrier 22 shown in FIG. 5.

Plant carrier embodiment 220 includes three inner shelves 222a,b,c which extend into the upper opening of the plant carrier 220, as best seen in the top view of FIG. 11B. The shelves 222a,b,c are provided to support a flexible collar 401 which is illustrated in FIGS. 12A and 12B. The collar 401 is provided as a plug-like insert member to support a small plant in an early growth stage as its upper portions extend outward and upward from the top of the plant carrier 220. The collar 401 is advantageously formed of a flexible foam or rubber polymer and has a central aperture 402 extending to a slit 403 which extends to the edge of the collar 401. The flexibility of the collar 402 permits adjacent edges of the slit 403 to be pulled apart so that the collar 401 can be placed around the small relatively fragile stem of a small plant in an early growth stage to place the edges of the aperture 402 of the collar 401 against the stem of the plant, thereby centralizing the stem of the plant in the plant carrier 220 as illustrated in the side view of FIG. 12B. In this particular arrangement, the collar 401 is dimensioned to fit into the upper opening of the plant carrier 220 with a snug press fit similar to a conventional plug fitting into a drain.

The features of the example plant carrier embodiment 220 described above provide significant improvements over conventional net pots. In one aspect, the plant carrier 220 provides windows between the support members 224a,b,c which extend from the ring portion 229 to the bowl portion 228 without the presence of any cross members between the support members 224a,b,c. These windows, which extend across a majority length of the plant carrier 220 enable the roots of the growing plant to more effectively extend outward into the growth medium held in the container 120. This effective spreading of roots provides more access to the growth medium and improves plant growth.

The components of the apparatus may be provided as a commercial product in the form of a kit which includes two or more lids having different arrangements of one or more apertures. It would be appropriate to grow a plurality of plants from seeds or clones in a plurality of plant carriers installed within a plurality of apertures in a single container lid covering a container and then at a growth stage when the upper portions of the plant are larger, the plant carrier could be moved to a different container having a lid with fewer apertures or only one central aperture to provide more space above the lid to promote further growth of the plant. The lids may have any of the lid features described herein. Such a kit may include one or more containers such as the container embodiment shown in FIGS. 1, 3, 7A and 7B for example, as well as one or more plant carriers such as the embodiments of the plant carriers 22 and 220 described herein and illustrated in FIGS. 2A, 2B, 5, 11 and 12. The kit may include instructions for growing a plurality of seeds or clones into plants using a first lid and one of the containers and to transfer one of the plants, to a second lid and another one of the containers upon reaching an indicated growth stage. The kit may also include scaffold members configured for assembly on lids such as the lid embodiments 260 and 360, for example. The kits may also include collars for the plant carriers, such as the collar embodiment 401 illustrated in connection with plant carrier 220 in FIGS. 12A and 12B.

Various embodiments of the technology described herein have several advantages. Embodiments of the plant carrier permit growth of plants without using medium and are reusable as well as being dishwasher safe, while conventional net pots typically become warped or broken after a single use. The plant carrier provides improved circulation of air and fluid and allows roots of a growing plant to be easily treated and manipulated, for example by spraying with nutrients. Embodiments of the container protect the roots of the plant completely from ambient light (which prevents growth of algae) and separates them into portions growing out of the large circumferential windows of the plant carrier. This prevents formation of a tangled root ball, which is more challenging to manipulate. This improves plant stability, decreases growing time and increases yields by reducing root stress caused from standard net pots as well as permitting a grower to train the growth of the roots. The ability to transfer a plant carrier from one container to another increases efficiency and prevents root damage which tends to occur when a plant is removed from a conventional net pot.

Embodiments of the apparatus permit plants to grow in the absence of medium in essentially all growth stages beginning at the seed or clone stage. Growing in the absence of common media such as soil prevents infiltration of pests which are typically associated with growth media. The plant carrier can hold a seed, a clone or a growing cube holding a seed or clone. The extensions on the lid provide a means for supporting the stem of a growing plant as well as supporting the entire lid and the plant carrier when the contents of the container are being exchanged.

Other than described herein, or unless otherwise expressly specified, all of the numerical ranges, amounts, values and percentages in the specification and attached claims may be read as if prefaced by the word “about” even though the term “about” may not expressly appear with the value, amount, or range. Accordingly, unless indicated to the contrary, the numerical parameters set forth in the following specification and attached claims are approximations that may vary depending upon the desired properties sought to be obtained by the present technology. At the very least, and not as an attempt to limit the application of the doctrine of equivalents to the scope of the claims, each numerical parameter should at least be construed in light of the number of reported significant digits and by applying ordinary rounding techniques.

Any patent, publication, internet site, or other disclosure material, in whole or in part, that is said to be incorporated by reference herein is incorporated herein only to the extent that the incorporated material does not conflict with existing definitions, statements, or other disclosure material set forth in this disclosure. As such, and to the extent necessary, the disclosure as explicitly set forth herein supersedes any conflicting material incorporated herein by reference. Any material, or portion thereof, that is said to be incorporated by reference herein, but which conflicts with existing definitions, statements, or other disclosure material set forth herein will only be incorporated to the extent that no conflict arises between that incorporated material and the existing disclosure material.

Unless otherwise defined, all technical and scientific terms used herein have the same meaning as commonly understood by one of ordinary skill in the art to which this technology belongs.

While this technology has been particularly shown and described with references to embodiments thereof, it will be understood by those skilled in the art that various changes in form and details may be made therein without departing from the scope of the technology encompassed by the appended claims.

In the claims, articles such as “a,” “an,” and “the” may mean one or more than one unless indicated to the contrary or otherwise evident from the context. Claims or descriptions that include “or” between one or more members of a group are considered satisfied if one, more than one, or all of the group members are present in, employed in, or otherwise relevant to a given product or process unless indicated to the contrary or otherwise evident from the context.

It is also noted that the term “comprising” is intended to be open and permits but does not require the inclusion of additional elements or steps. When the term “comprising” is used herein, the term “consisting of” is thus also encompassed and disclosed. Where ranges are given, endpoints are included. Furthermore, it is to be understood that unless otherwise indicated or otherwise evident from the context and understanding of one of ordinary skill in the art, values that are expressed as ranges can assume any specific value or subrange within the stated ranges in different embodiments of the technology, to the tenth of the unit of the lower limit of the range, unless the context clearly dictates otherwise. Where the term “about” is used, it is understood to reflect +/- 10% of the recited value. In addition, it is to be understood that any particular embodiment of the present technology that falls within the prior art may be explicitly excluded from any one or more of the claims. Since such embodiments are deemed to be known to one of ordinary skill in the art, they may be excluded even if the exclusion is not set forth explicitly herein.

What is claimed is:

1. A plant growth apparatus, the apparatus comprising:
a container defined by a main cylindrical portion with a main upper opening and a lateral reservoir in fluid communication with the main cylindrical portion, the lateral reservoir having a reservoir opening angled downward from the upper opening;
a lid configured for connection to the main upper opening, the lid defined by one or more apertures; and
a plant carrier configured for connection to the one or more apertures, such that a majority portion of the plant carrier extends into the main cylindrical portion to become immersed in growth medium held in the container, when the apparatus is in use.

2. The apparatus of claim 1, further comprising a cover for the reservoir opening.

3. The apparatus of claim 2, wherein the reservoir cover includes an upper angled portion and a horizontal portion, wherein the horizontal portion is bendable and biased downwards to a normally horizontal orientation.

4. The apparatus of claim 1, wherein the reservoir opening of the container is defined by opposed angled edges of the lateral reservoir configured to connect to the upper angled portion of the reservoir cover, the opposed angled edges joining a forward horizontal edge configured to connect to the horizontal portion of the reservoir cover.

5. The apparatus of claim 1, wherein the lid includes a plurality of peripheral tabs configured to connect to scaffold members to provide an upper plant support structure.

6. The apparatus of claim 1, wherein the lid is radially tapered downward to provide a drain slope towards each of the one or more apertures.

7. The apparatus of claim 1, wherein the plant carrier comprises a plurality of ridges below an upper peripheral edge of the plant carrier, the plurality of ridges configured to fit into peripheral grooves formed adjacent to the one or more apertures, thereby providing a connection mechanism for connecting the plant carrier to the lid.

8. The apparatus of claim 1, wherein the plant carrier comprises a plurality of support members extending from an upper ring portion downward to a bowl portion.

9. The apparatus of claim 8, wherein the support members are angled inwardly towards the bowl portion, thereby providing the plant carrier with a frustoconical shape which facilitates centralization of the bowl portion and connection of the plant carrier to one of the one or more apertures of the lid without disturbing roots of a plant extending therefrom.

10. The apparatus of claim 8, wherein the plant carrier does not include cross members between the support members.

11. The apparatus of claim 8, wherein the bowl portion is an inverted bowl formed of a central flat portion and a plurality of downward extensions.

12. The apparatus of claim 8, wherein the plant carrier comprises a plurality of shelves extending from an inner surface of the ring portion into a main opening of the plant carrier, the plurality of shelves provided to support a collar for centralizing and supporting a plant within the plant carrier.

13. The apparatus of claim 8, wherein the upper peripheral edge of the plant carrier is polygonal in shape to present a plurality of corners to facilitate manual disconnection of the plant carrier from the lid.

14. The apparatus of claim 13 wherein the upper peripheral edge of the plant carrier is octagonal in shape.

15. The apparatus of claim 1, wherein the reservoir opening has an area of about 110 cm² to about 156 cm².

16. The apparatus of claim 15, wherein the area of the reservoir opening is greater than an area of the bottom surface of the reservoir.

17. The apparatus of claim 16, wherein the area of the bottom surface of the reservoir is about 76.5 cm² to about 95 cm².

18. A kit for assembling a plant growth apparatus, the kit comprising:
a container defined by a main cylindrical portion with a main upper opening and a lateral reservoir in fluid communication with the main cylindrical portion, the lateral reservoir having a reservoir opening angled downward from the upper opening; and
a cover for the reservoir opening.

19. The kit of claim 18, wherein the cover includes an upper angled portion and a horizontal portion, wherein the horizontal portion is bendable and biased downwards to a horizontal orientation.

20. The kit of claim 18, further comprising: one or more lids configured for connection to the main upper opening, the lids defined by one or more apertures.

21. The kit of claim 20, further comprising a plurality of scaffold members configured for connection to the one or more lids.

22. The kit of claim 20, further comprising: one or more plant carriers configured for connection to the one or more apertures.

23. The kit of claim 22, further comprising one or more collars for supporting a plant extending from the one or more plant carriers.
